(19) United States
(12) Patent Application Publication
(10) Pub. No.: US 2008/0136962 A1
(43) Pub. Date: Jun. 12, 2008

(54) MULTI-OUTPUT SYSTEM AND METHOD

(75) Inventor: Tae Sun YOON, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/778,740

(22) Filed: Jul. 17, 2007

(30) Foreign Application Priority Data
Dec. 7, 2006 (KR) 2006-123937

(51) Int. Cl. H04N 11/22

(52) U.S. Cl. 348/445

(57) ABSTRACT

An output system and method, and, more particularly, a multi-output system and method capable of simultaneously outputting data to a plurality of output apparatuses are disclosed. The multi-output system includes: a reception unit which receives data to be output; a storage unit which stores a plurality of different conversion formats; a selection unit which allows a plurality of conversion formats to be selected from the conversion formats stored in the storage unit; a conversion unit which converts the received data into the plurality of the selected conversion formats; and an output unit which outputs the converted data into a predetermined output apparatus.

### CROSS-REFERENCE TO RELATED APPLICATIONS

This application claims priority under 35 U.S.C. §119(a) from Korean Patent Application No. 2006-123937, filed on Dec. 7, 2006 in the Korean Intellectual Property Office, the disclosure of which is incorporated herein in its entirety by reference.

### BACKGROUND OF THE INVENTION

1. Field of the Invention

The present general inventive concept relates to an output system and method, and more particularly, to a multi-output system and method to output data to a plurality of output apparatuses.

2. Description of the Related Art

Generally, a conventional apparatus for outputting image data onto a sheet of paper, such as a printer, a multifunctional machine, a copier, a facsimile machine, and a scanner is called an image forming apparatus.

In a method of outputting image data using the image forming apparatus, the image data to be output is received via an operating system (OS) of a computer.

Next, the image data is configured into an output format of the image forming apparatus and then the image data is stored in a print spooler via a printer driver.

Spool is configured to read a document or a job list from a computer and store the document or the job list in a hard disc or a mass storage medium such that the document or the job list is printed at a convenient time, and the print spooler is a program for extracting the image data one by one in input order.

The image data stored in the print spooler is transmitted to the image forming apparatus via a communication interface. The image forming apparatus sends the received image data to an image forming engine via the communication interface, thereby outputting an image.

However, in order to uniformly set printer functions and form image data with different printer languages, that is, in order to verify the printer or check reproducibility of the printer language due to an undesirable output, there is a disadvantage in that different printer drivers must be uniformly set.

When the image data is converted into a format other than the printer language, such as a portable document format (PDF) or a tagged image file format (TIFF), the printer drivers must be set separately in order to print the image data.

### SUMMARY OF THE INVENTION

The present general inventive concept provides a multi-output system and method to prevent the disadvantage that printer drivers have to be uniformly set in order to uniformly set printer functions and to form image data with different printer languages and output data in a plurality of formats.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a multi-output system, including a reception unit which receives data to be output, a storage unit which stores a plurality of conversion formats, a selection unit which allows a plurality of conversion formats to be selected from the conversion formats stored in the storage unit, a conversion unit which converts the received data into the plurality of the selected conversion formats, and an output unit which outputs the converted data into a predetermined output apparatus.

The selection unit may display the plurality of conversion formats using a predetermined screen display device such that a user can select the conversion formats.

The conversion unit may convert the received data into the plurality of conversion formats which are previously stored as the selected conversion formats, when a plurality of conversion formats is not selected by a user.

The selection unit may allow a number of output formats to be selected and allow the conversion formats to be selected according to the number of selected output formats.

The selection unit may further allow output port information necessary to transmit the converted data to the predetermined output apparatus to be selected.

The selection unit may display the number of output formats, the conversion formats, and the output port information using a predetermined screen display device.

The output port information may be at least one of local information and network port information.

The conversion unit may simultaneously convert the received data into the plurality of selected conversion formats.

The conversion unit may sequentially convert the received data into the plurality of selected conversion formats.

The foregoing and/or other aspects and utilities of the present general inventive concept are also achieved by providing a multi-output method, including receiving data to be output, selecting a plurality of conversion formats from a plurality of different conversion formats which are previously stored, converting the received data into the plurality of selected conversion formats, and outputting the converted data to a predetermined output apparatus.

The selecting of the plurality of conversion formats may include displaying the plurality of different conversion formats which are previously stored and allowing a user to select the plurality of conversion formats using a predetermined screen display device.

When a plurality of conversion formats is not selected by a user, the received data may be converted into the plurality of conversion formats which are previously stored.

The foregoing and/or other aspects and utilities of the present general inventive concept are also achieved by providing a multi-output method, including receiving data to be output, selecting a number of output formats, selecting conversion formats according to the number of selected output formats, converting the received data into the selected conversion formats, and outputting the converted data to a predetermined output apparatus.

When the conversion formats are selected, output port information necessary to transmit the converted data to the predetermined output apparatus may be further selected.

The output port information may be at least one of local information and network port information.

When the received data is converted to the selected conversion formats, the received data may be simultaneously converted into the plurality of conversion formats.

When the received data is converted to the selected conversion formats, the received data may be sequentially converted into the plurality of conversion formats.

The foregoing and/or other aspects and utilities of the present general inventive concept are also achieved by providing a multi-output system, including a receiver to receive data to be output, a selection unit to select a number of output formats, a conversion unit to convert the received data to the selected output formats, and an output unit to output the converted data to a predetermined output apparatus.

The multi-output system may further include a storage unit to store a predetermined number of conversion formats.

The selection unit may select the stored conversion formats as the output formats if the output formats are not selected by a user.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating a multi-output system according to an embodiment of the present general inventive concept;

FIG. 2 is a schematic diagram illustrating a multi-output procedure of the multi-output system of FIG. 1;

FIG. 3 is a view illustrating a screen to allow a user to select a plurality of conversion formats;

FIGS. 4A to 4D are views illustrating screens to allow the user to select a number of output formats and to select conversion formats by the number of output formats;

FIG. 5 is a view illustrating a screen to display an authentication operation necessary to transmit converted data to a desired location;

FIG. 6 is a flowchart illustrating a multi-output method according to an embodiment of the present general inventive concept; and

FIG. 7 is a flowchart illustrating a multi-output method according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

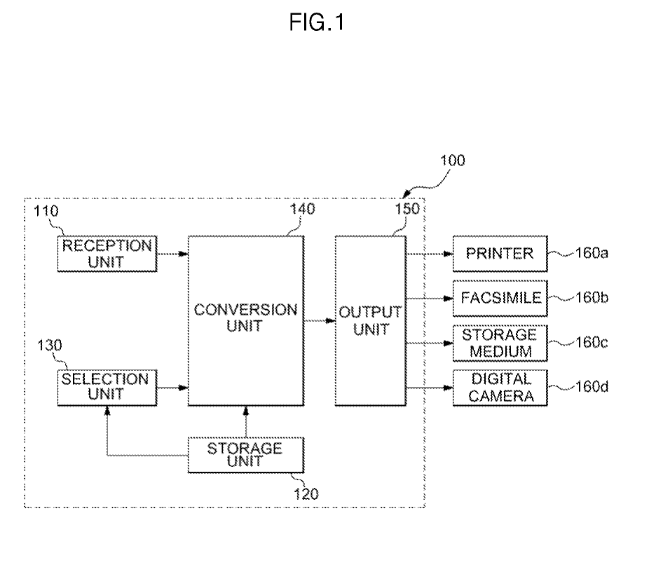

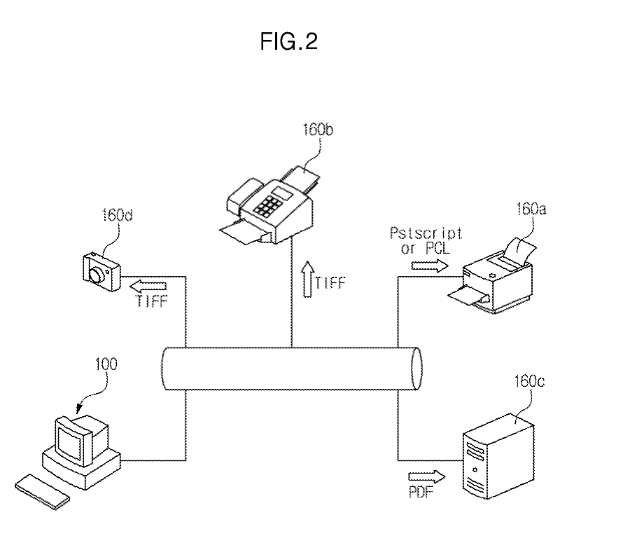

FIG. 1 is a block diagram illustrating a multi-output system according to an embodiment of the present general inventive concept, and FIG. 2 is a schematic diagram illustrating a multi-output procedure of the multi-output system of FIG. 1. As illustrated in FIGS. 1 and 2, the multi-output system 100 may include a reception unit 110, a storage unit 120, a selection unit 130, a conversion unit 140, and an output unit 150.

First, the reception unit 110 receives data to be output via an operating system (OS). The OS can be a set of system programs to control and adjust an overall operation of a computer system. The OS can also function as an interface between hardware and an application program, and can manage computer resources, such as, a central processing unit (CPU), a main memory unit, and an input/output apparatus.

That is, the OS can provide an interaction between an operator, such as a person, and a computer, can drive an operation of the computer, decide an order of jobs, and control an input/output operation.

In addition, the OS can control execution of a program and manage storage of data and files.

Next, the storage unit 120 stores a plurality of different conversion formats.

The conversion format is a format which can be output by the image forming apparatus, that is, an output apparatus, and can be at least one of a print control language (PCL), a postscript, a raster, a portable document format (PDF), and a tagged image file format (TIFF).

The PCL is a printer control language and the postscript is a page description language developed by Adobe Systems Inc. of the United States in order to adjust a function of a printer.

The raster is related to a cathode ray tube (CRT) or liquid crystal display (LCD) monitor to display an image, and the PDF is a document file format which can be viewed, searched, or printed by a user, or delivered to another person.

In particular, since a print state is displayed through the computer, the PDF is suitable for a digital publication, such as an electronic book or a CD publication. In addition, an official document or an important document may be delivered on-line by encrypting the document to secure secrecy.

Finally, TIFF is a type of raster image file format. The TIFF is a standard file format which is widely used to scan, store, and exchange a monochromic or halftone still image, and is characterized in that an attribute of image data is defined as tag information.

In a case of an image file in the TIFF, an application program can recognize the data format by reading standardized tag information which is described in a front part of the image file.

The conversion format can be at least one of the PCL, the postscript, the raster, the PDF, and the TIFF. However, the present general inventive concept is not limited thereto, and any conversion format which can be interpreted and output by the output apparatus 160 may be used.

Next, the selection unit 130 allows the user to select a plurality of conversion formats from conversion formats stored in the storage unit 120.

At this time, the selection unit 130 displays the conversion formats using a predetermined screen display device such that the user selects the plurality of conversion formats.

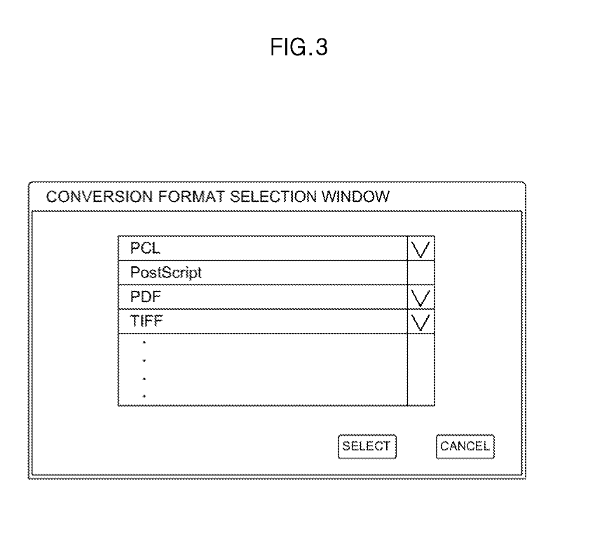

FIG. 3 is a view illustrating a screen to allow the user to select the plurality of conversion formats. As illustrated in FIG. 3, a window to select the conversion format is output using the predetermined screen display device and the user can select the plurality of conversion formats suitable for an output format.

For example, if the user wants to select the PCL, the PDF, and the TIFF, the PCL, the PDF, and the TIFF are selected in the window to select the conversion format.

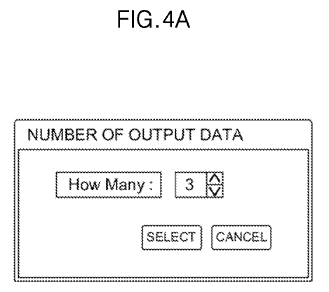

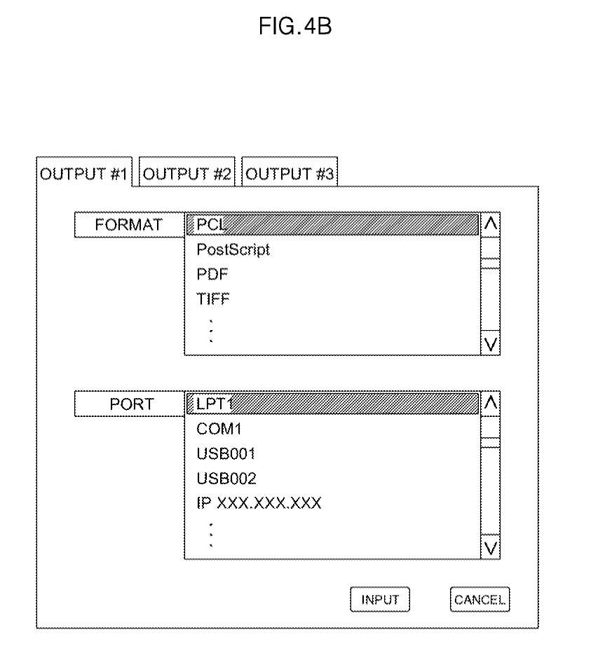

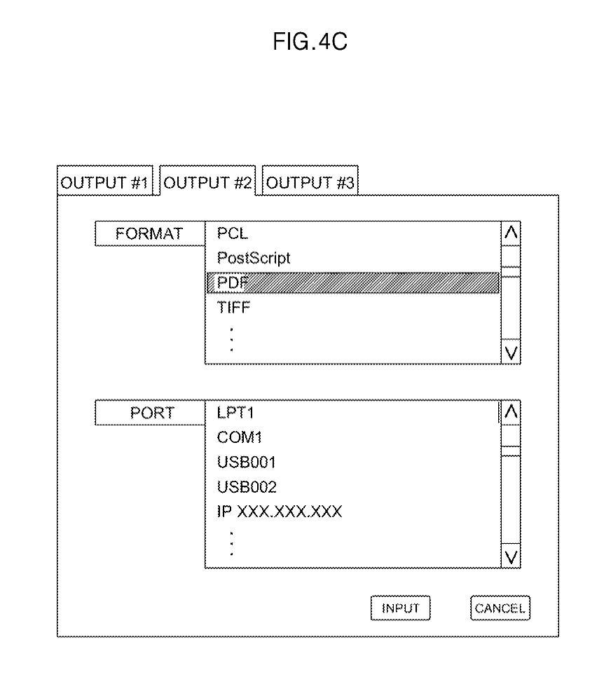

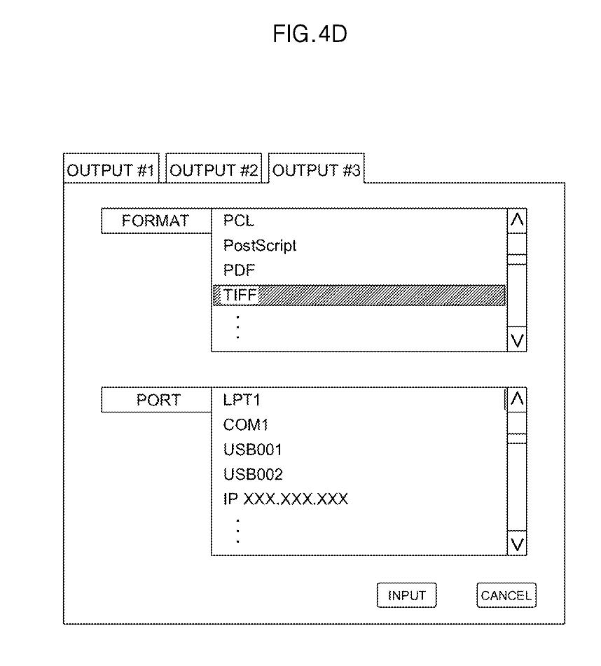

Meanwhile, FIGS. 4A to 4D are views illustrating screens to allow the user to select the number of output formats and to select conversion formats by the number of output formats. As illustrated in FIG. 4A, the selection unit 130 allows the user to select the number of output formats.

The number of output formats can be at least two. After the number of output formats is selected, the conversion formats can be further selected according to the number of output formats.

As illustrated in FIG. 4A, if the number of output formats is, for example, three, the screen selection windows to select the conversion formats by the number of output formats are output.

That is, three screen selection windows are output. First, as illustrated in FIG. 4B, a first screen display window is output so as to allow the user to select the PCL as the conversion format.

Next, as illustrated in FIG. 4C, a second screen display window is output so as to allow the user to select the PDF as the conversion format and, as illustrated in FIG. 4D, a third screen display window is output so as to allow the user to select the TIFF as the conversion format.

That is, if the number of output formats is two, two conversion formats are selected, and, if the number of output formats is three, three conversion formats are selected.

The selection unit 130 allows data in the PCL format to be output from, for example, a printer 1, and allows data in the postscript format to be output from, for example, a printer 2. Accordingly, it is possible to prevent the cumbersomeness that the user must select the printer according to the format of the data.

Then, the conversion unit 140 converts the received data into the plurality of selected conversion formats.

That is, the received data is converted into the PCL, the PDF, and the TIFF selected in FIG. 3.

If the plurality of conversion formats is not selected by the user, the conversion unit 140 can convert the received data into the plurality of conversion formats which are previously stored in the storage unit 120.

That is, when a plurality of conversion formats is not selected by the user, the conversion formats to be converted are the conversion formats previously stored in the storage unit 120.

For example, if the conversion formats are not selected by the user, and the PCL and the PDF conversion formats are previously stored in the storage unit 120, and information on the conversion formats selected by the selection unit 130 is not input, the conversion unit 140 receives the information on the conversion formats which are previously stored in the storage unit 120 and converts the received data into the PCL and the PDF.

At this time, the conversion unit 140 can sequentially convert the received data into the plurality of selected conversion formats.

For example, the conversion unit 140 can convert the received data into the PCL and then can convert the received data into the PDF.

Alternatively, the conversion unit 140 can simultaneously convert the received data into the plurality of selected conversion formats. At this time, since the conversion unit 140 generates and allocates independent threads so as to simultaneously perform the conversion, a conversion speed can be improved.

After the conversion of the received data, the output unit 150 outputs the converted data to a predetermined output apparatus.

The predetermined output apparatus can be the image forming apparatus to output data onto a sheet of paper, such as a printer 160a, a multifunctional machine, a facsimile machine 160b, a digital camera 160d, or a scanner. The predetermined output apparatus may be a storage medium 160c to store the converted data.

That is, for example, the output unit 150 can output the data in the PDF to the storage medium 160c, the data in the PCL to the printer 160a, and the data in the TIFF to the facsimile machine 160b, among the converted data including the data in the PDF format, the data in the PCL and the data in the TIFF, as illustrated in FIG. 2.

Meanwhile, the selection unit 130 further allows output port information necessary to transmit the converted data to the predetermined output apparatus to be selected.

The output port information includes at least one of preset local information or network port information and may include LPT, COM, USB001, USB002, and IP information, as illustrated in FIGS. 4B to 4D.

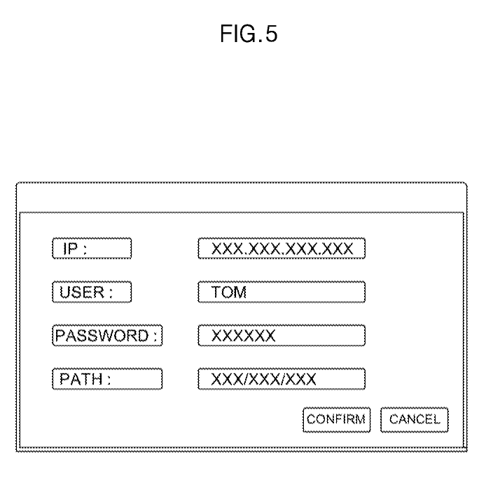

FIG. 5 is a view illustrating a screen to display an authentication operation necessary to transmit the converted data to a desired location. As illustrated in FIG. 5, the authentication operation to log into a server is performed in order to transmit the converted data to a desired location.

That is, after the authentication operation is performed by, for example, inputting the address of an IP connected to a network, a user name, a password and a transmission path, the converted data can be transmitted to the desired location.

Hereinafter, a multi-output method according to an embodiment of the present general inventive concept will be described.

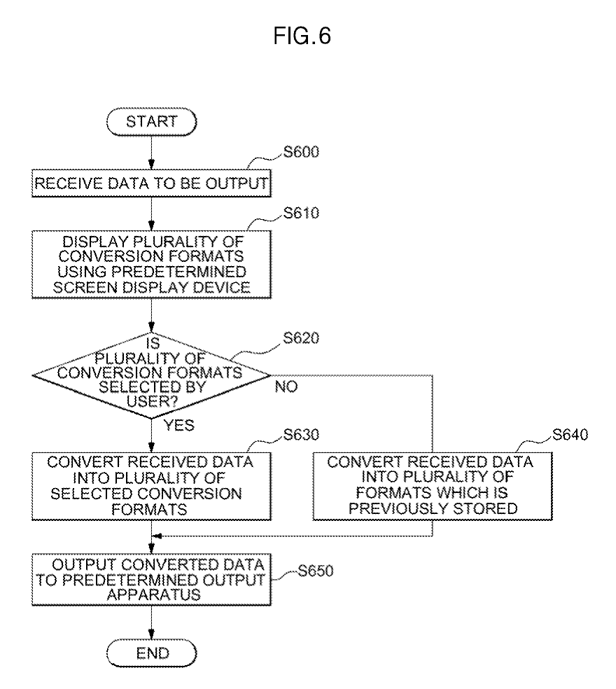

FIG. 6 is a flowchart illustrating a multi-output method according to an embodiment of the present general inventive concept. As illustrated in FIG. 6, data to be output is received in operation S600.

Next, a plurality of different conversion formats which are previously stored is displayed using, for example, a predetermined screen display device such that a user can select the conversion formats.

The predetermined screen display device displays the plurality of different conversion formats which are previously stored and may include devices, such as a liquid crystal display (LCD), a plasma display panel (PDP), a thin-film transistor (TFT) LCD, an organic electroluminescence (EL) LCD, and a cathode ray tube (CRT).

Next, it is determined whether a plurality of conversion formats is selected by the user in operation S620. If the plurality of conversion formats is selected by the user, the received data is converted into the plurality of conversion formats in operation S630.

If a plurality of conversion formats is not selected by the user, the received data is converted to the plurality of conversion formats which are previously stored in operation S640.

After the conversion of the received data, the converted data is output to a predetermined output apparatus in operation S650.

Here, the predetermined output apparatus can be an image forming apparatus to output data to a sheet of paper, such as a printer, a multifunctional machine, a copier, a facsimile machine, and a scanner. The predetermined output apparatus may also be a storage medium to store the converted data.

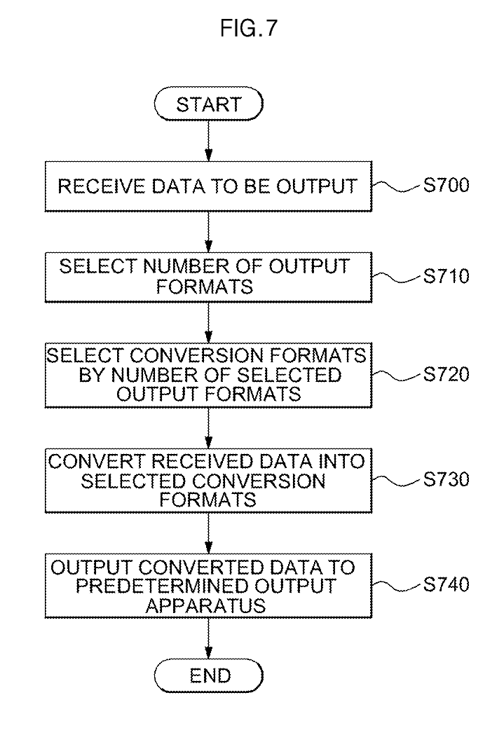

FIG. 7 is a flowchart illustrating a multi-output method according to another embodiment of the present general inventive concept. As illustrated in FIG. 7, data to be output is received in operation S700.

Next, a number of output formats is selected in operation S710 and conversion formats are selected by the number of output formats in operation S720.

For example, when the number of output formats which are selected by the user is two, two conversion formats corresponding to the two output formats are selected.

At this time, output port information necessary to transmit the converted data to a predetermined output apparatus can be further selected.

Here, the output port information is, for example, at least one of local information and network port information and may include LPT, COM, and USB information.

Next, the received data is converted into the selected conversion formats in operation S730.

At this time, the received data may be sequentially converted into the plurality of selected conversion formats. Alternatively, the received data may be simultaneously converted into the plurality of conversion formats. In this case, since independent threads can be generated and allocated to simultaneously perform the conversion, a conversion speed can be improved.

After the received data is converted into the selected conversion formats, the converted data is output to a predetermined output apparatus in operation S740.

As described above, according to a multi-output system and method of the present general inventive concept, since different data is output to a printer and at the same time, stored in a storage medium, the data which is output by a user can be checked by another user and the data can be recovered when the data is lost or damaged.

In order to verify a printer or check reproducibility of a printer language due to an undesirable output, it is possible to prevent the cumbersomeness that different printers are uniformly set.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A multi-output system, comprising:
a reception unit which receives data to be output;
a storage unit which stores a plurality of conversion formats;
a selection unit which allows a plurality of conversion formats to be selected from the conversion formats stored in the storage unit;
a conversion unit which converts the received data into the plurality of the selected conversion formats; and
an output unit which outputs the converted data into a predetermined output apparatus.

2. The system according to claim 1, wherein the selection unit displays the plurality of conversion formats using a predetermined screen display device such that a user selects the conversion formats.

3. The system according to claim 1, wherein the conversion unit converts the received data into the plurality of conversion formats which are previously stored as the selected conversion formats, when a plurality of conversion formats is not selected by a user.

4. The system according to claim 1, wherein the selection unit allows a number of output formats to be selected and allows the conversion formats to be selected according to the number of selected output formats.

5. The system according to claim 4, wherein the selection unit further allows output port information necessary to transmit the converted data to the predetermined output apparatus to be selected.

6. The system according to claim 4, wherein the selection unit displays the number of output formats, the conversion formats, and the output port information using a predetermined screen display device.

7. The system according to claim 5, wherein the output port information is at least one of local information and network port information.

8. The system according to claim 1, wherein the conversion unit simultaneously converts the received data into the plurality of selected conversion formats.

9. The system according to claim 1, wherein the conversion unit sequentially converts the received data into the plurality of selected conversion formats.

10. A multi-output method, comprising:
receiving data to be output;
selecting a plurality of conversion formats from a plurality of different conversion formats which are previously stored;
converting the received data into the plurality of selected conversion formats; and
outputting the converted data to a predetermined output apparatus.

11. The method according to claim 10, wherein the selecting of the plurality of conversion formats comprises displaying the plurality of different conversion formats which are previously stored and allowing a user to select the plurality of conversion formats using a predetermined screen display device.

12. The method according to claim 10, wherein, when a plurality of conversion formats is not selected by a user, the received data is converted into the plurality of conversion formats which are previously stored.

13. A multi-output method, comprising:
receiving data to be output;
selecting a number of output formats;
selecting conversion formats according to the number of selected output formats;
converting the received data into the selected conversion formats; and
outputting the converted data to a predetermined output apparatus.

14. The method according to claim 13, wherein, when the conversion formats are selected, output port information necessary to transmit the converted data to the predetermined output apparatus is further selected.

15. The method according to claim 14, wherein the output port information is at least one of local information and network port information.

16. The method according to claim 13, wherein, when the received data is converted to the selected conversion formats, the received data is simultaneously converted into the plurality of conversion formats.

17. The method according to claim 13, wherein, when the received data is converted to the selected conversion formats, the received data is sequentially converted into the plurality of conversion formats.

18. A multi-output system, comprising:
a receiver to receive data to be output;
a selection unit to select a number of output formats;
a conversion unit to convert the received data to the selected output formats; and
an output unit to output the converted data to a predetermined output apparatus.

19. The multi-output system of claim 18, further comprising:
a storage unit to store a predetermined number of conversion formats.

20. The multi-output system of claim 19, wherein, the selection unit selects the stored conversion formats as the output formats if the output formats are not selected by a user.
